(19) United States
(12) Patent Application Publication
(10) Pub. No.: US 2023/0082882 A1
(43) Pub. Date: Mar. 16, 2023

(54) METHOD OF DRIVING DISPLAY PANEL AND DISPLAY PANEL DRIVING APPARATUS

(71) Applicant: KUNSHAN GO-VISIONOX OPTO-ELECTRONICS CO., LTD, Kunshan (CN)

(72) Inventors: Yuqing WANG, Kunshan (CN); Xinquan CHEN, Kunshan (CN); Xiaobao ZHANG, Kunshan (CN)

(73) Assignee: KUNSHAN GO-VISIONOX OPTO-ELECTRONICS CO., LTD, Kunshan (CN)

(21) Appl. No.: 17/984,706

(22) Filed: Nov. 10, 2022

Related U.S. Application Data
(63) Continuation of application No. PCT/CN2021/101438, filed on Jun. 22, 2021.

(30) Foreign Application Priority Data
Aug. 10, 2020 (CN) 202010796934.6

(51) Int. Cl. G09G 3/3266

(52) U.S. Cl. CPC G09G 3/3266; G09G 2300/0842; G09G 2320/0233; G09G 2330/021; G09G 2320/0247

(57) ABSTRACT

A method of driving a display panel and a display panel driving apparatus. The method of driving a display panel includes acquiring an operation instruction of the display panel; determining an application mode of the display panel according to the operation instruction, where different application modes correspond to different refresh rates; and switching a refresh rate of the display panel to a refresh rate corresponding to the application mode according to the application mode of the display panel and calling drive data corresponding to the application mode.

### CROSS-REFERENCE TO RELATED APPLICATIONS

This is a continuation of International Patent Application No. PCT/CN2021/101438, filed on Jun. 22, 2021, which claims priority to Chinese Patent Application No. 202010796934.6 filed on Aug. 10, 2020, the disclosures of which are incorporated herein by reference in their entireties.

### TECHNICAL FIELD

Embodiments of the present application relate to the field of display technology, for example, a method of driving a display panel and a display panel driving apparatus.

### BACKGROUND

In the application process of a display panel, different application scenarios have different requirements for a refresh rate. Thus, it is necessary to configure the refresh rate of the display panel to be a dynamic refresh rate. Limited by the pixel drive circuit of the display panel, the display panel is prone to problems such as a high luminance, an instantaneous screen flicker, an abnormal luminance every other column and an uneven display when the refresh rate of the display panel is adjusted from a low rate to a high rate.

### SUMMARY

The present application provides a method of driving a display panel and a display panel driving apparatus to achieve the automatic switch of the refresh rates of the display panel and to ensure the display quality of the display panel at different refresh rates.

In a first aspect, an embodiment of the present application provides a method for driving a display panel. The method includes the steps below.

An operation instruction of the display panel is acquired.

An application mode of the display panel is determined according to the operation instruction. Different application modes correspond to different refresh rates.

A refresh rate of the display panel is switched to a refresh rate corresponding to the application mode according to the application mode of the display panel and drive data corresponding to the application mode is called.

In a second aspect, an embodiment of the present application provides a display panel driving apparatus. The apparatus includes an operation instruction acquisition module, an application mode determination module and a switch module.

The operation instruction acquisition module is configured to acquire an operation instruction of the display panel.

The application mode determination module is configured to determine an application mode of the display panel according to the operation instruction. Different application modes correspond to different refresh rates.

The switch module is configured to switch a refresh rate of the display panel to a refresh rate corresponding to the application mode according to the application mode of the display panel and call drive data corresponding to the application mode.

In the technical schemes of the embodiments of the present application, after the operation instruction of the display panel is acquired, the application mode of the display panel is determined according to the operation instruction, and the refresh rate of the display panel is automatically switched according to the application mode. In this manner, different application modes of the display panel correspond to different refresh rates. Thus, the seamless and smooth switch of the refresh rate of the display panel can be achieved to avoid problems such as a screen flicker and a color cast. Moreover, phenomena such as a lag, vertigo and a motion blur at a high refresh rate can be effectively solved, and the experience effect of the high refresh rate can be improved. Additionally, when the display panel switches the refresh rate, the drive data corresponding to the application mode is called to ensure the display quality of the display panel at different refresh rates and reduce the number of complex instructions sent by a mainboard. Thus, the electricity consumption of the mainboard can be saved, and the standby time of the display panel can be prolonged.

### BRIEF DESCRIPTION OF DRAWINGS

FIG. 1 is a structural diagram of a pixel drive circuit.

FIG. 2 is a flowchart of a method of driving a display panel according to an embodiment of the present application.

FIG. 3 is a flowchart of another method of driving a display panel according to an embodiment of the present application.

FIG. 4 is a flowchart of another method of driving a display panel according to an embodiment of the present application.

FIG. 5 is a luminance-grayscale graph illustrating that gamma data of 90 Hz is shared with 120 Hz.

FIG. 6 is a luminance-grayscale graph illustrating that gamma data of 144 Hz is shared with 120 Hz.

FIG. 7 is a flowchart of another method of driving a display panel according to an embodiment of the present application.

FIG. 8 is a structural diagram of a display panel driving apparatus according to an embodiment of the present application.

### DETAILED DESCRIPTION

With the mature development of the display panel industry, a display panel has different requirements for the refresh rate in different application scenarios. For example, when some relatively static pictures are displayed, the refresh rate may be reduced to save power consumption. For a relatively high display requirement, the refresh rate may be increased to improve the display quality. Therefore, the refresh rate of the display panel is configured to be adjustable to effectively reduce the power consumption of the display screen and to improve the picture display quality. The display panel includes multiple pixel units. Each pixel unit includes a pixel drive circuit.

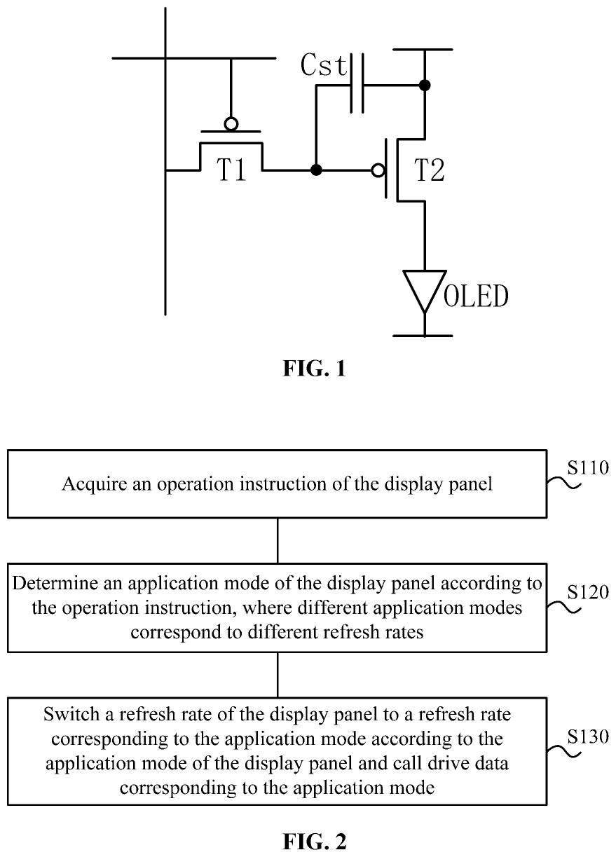

As shown in FIG. 1, the pixel drive circuit includes a first transistor T1, a second transistor T2, a storage capacitor Cst and a light-emitting device, i.e., an organic light-emitting diode (OLED). When the pixel drive circuit operates, a drive current generated by the second transistor T2 drives the light-emitting device OLED to emit light. The magnitude of the drive current of the second transistor T2 is controlled by a gate voltage of the second transistor T2. The gate voltage of the second transistor T2 is a data voltage Vdata provided by a data line through the first transistor T1 and maintained by the storage capacitor Cst, that is, the data voltage Vdata needs to be charged to the storage capacitor Cst. When the refresh rate of the display panel becomes high, the time in which the data voltage Vdata of the pixel drive circuit is charged to the storage capacitor Cst becomes short, resulting in that the data voltage Vdata is not sufficiently written to the storage capacitor Cst, and the gate-source voltage difference of the second transistor T2 becomes great. Thus, the drive current generated by the second transistor T2 becomes great, and the luminance of the light-emitting device OLED increases. As a result, the display panel is too bright. Additionally, at the moment when the refresh rate of the display panel becomes high, the display panel is prone to suffer from problems such as a screen flicker, an abnormal luminance every other column and an uneven display. For the preceding problems, a mainboard may send instructions to a driver chip of the display panel to adjust the refresh rate. However, the process is complex, which is not conducive to the application of a client.

For the preceding technical problems, an embodiment of the present application provides a method of driving a display panel. This embodiment may be applied to the case where different application scenarios of the display panel correspond to different refresh rates. This method may be executed by a display panel driving apparatus. A display apparatus of the display panel may be integrated on the driver chip of the display panel. As shown in FIG. 2, this method includes S110 to S130.

In S110, an operation instruction of the display panel is acquired.

The operation instruction of the display panel is an instruction generated when a user of the display panel operates the display panel. For example, during the process of the user using the display panel, the user may operate the display panel to enable the display panel to open an application or to browse a web page. At this time, the instruction performed by the user is the operation instruction. Different operations performed by the user on the display panel form different operation instructions.

Additionally, before the operation instruction of the display panel is acquired, a power-up process of the display panel is further included. After the display panel is powered up, the data programmed in a programming process is loaded into the driver chip of the display panel, and then an initialization code is loaded into the driver chip of the display panel. Thus, the display panel can be normally driven for displaying.

In S120, an application mode of the display panel is determined according to the operation instruction. Different application modes correspond to different refresh rates.

After the operation instruction is formed, the operation instruction may be transmitted to the driver chip of the display panel. The driver chip includes a random-access memory (RAM). The RAM is configured to store a fixed program and data required for driving the display panel. For example, the RAM may store drive data. The RAM may further store set register values of the driver chip. Different register values may correspond to different application modes of the display panel. After the driver chip acquires the operation instruction, the driver chip determines a register value corresponding to the operation instruction according to the type of operation instruction and compares the register value with register values stored in the RAM. Thus, the application mode of the display panel may be determined according to a comparison result. For example, the operation instruction is of the type of static picture display, and the register value corresponding to the operation instruction is equal to a register value corresponding to an application mode stored in the RAM, so that when the driver chip receives the operation instruction of the static picture display, the application mode of the display panel is determined to be the application mode corresponding to the register value. Additionally, different application modes have different requirements for the refresh rate of the display panel. After the application mode corresponding to the operation instruction is determined, different refresh rates may be called according to the application mode.

In S130, the refresh rate of the display panel is switched to a refresh rate corresponding to the application mode according to the application mode of the display panel and drive data corresponding to the application mode is called.

The drive data includes data of a drive signal for driving the display panel to display and compensation data of the drive signal. For example, the drive signal may include a scan signal and a data signal. The compensation data of the drive signal may include compensation data of the data signal. After the application mode of the display panel is determined, the refresh rate of the display panel is switched according to the application mode of the display panel. Thus, the refresh rate of the display panel is switched to the refresh rate corresponding to the application mode to achieve the automatic switch of the refresh rate of the display panel. In this manner, the seamless and smooth switch of the refresh rate of the display panel can be achieved to avoid problems such as a screen flicker and a color cast. Moreover, phenomena such as a lag, vertigo and a motion blur at a high refresh rate can be effectively solved, and the experience effect of the high refresh rate can be improved. Additionally, different refresh rates correspond to different drive data. When the refresh rate of the display panel is switched, the drive data corresponding to the refresh rate of the display panel is called. Thus, after the refresh rate of the display panel is switched, the display panel can be normally driven for displaying, and the display quality of the display panel at different refresh rates is ensured. Moreover, the number of complex instructions sent by the mainboard may be reduced. Thus, the electricity consumption of the mainboard can be saved, and the standby time of the display panel can be prolonged.

In the technical schemes of this embodiment, after the operation instruction of the display panel is acquired, the application mode of the display panel is determined according to the operation instruction, and the refresh rate of the display panel is automatically switched according to the application mode. In this manner, different application modes of the display panel correspond to different refresh rates. Thus, the seamless and smooth switch of the refresh rate of the display panel can be achieved to avoid the problems such as the screen flicker and the color cast. Moreover, the phenomena such as the lag, the vertigo and the motion blur at a high refresh rate can be effectively solved, and the experience effect of the high refresh rate can be improved. Additionally, when the display panel switches the refresh rate, the drive data corresponding to the application mode is called to ensure the display quality of the display panel at different refresh rates and reduce the number of complex instructions sent by the mainboard. Thus, the electricity consumption of the mainboard can be saved, and the standby time of the display panel can be prolonged.

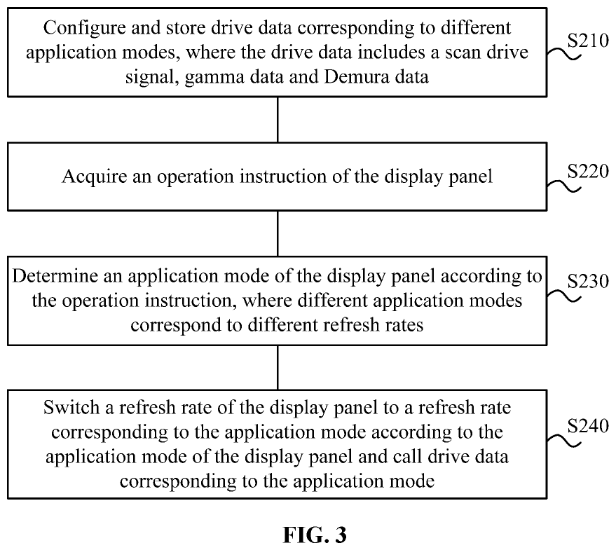

FIG. 3 is a flowchart of another method of driving a display panel according to an embodiment of the present application. As shown in FIG. 3, this method includes S210 to S240.

In S210, drive data corresponding to different application modes are configured and stored. The drive data includes scan drive signals, gamma data and Demura data.

Different application modes correspond to different refresh rates. Different refresh rates correspond to different drive data. In the program programming process of the display panel, the drive data corresponding to different application modes may be configured and stored. Thus, in the subsequent application process of the display panel, the drive data corresponding to the refresh rate may be called according to the refresh rate. The drive data corresponding to different application modes may be stored in the RAM or may be stored in a flash. The flash is communicatively connected to the driver chip through a serial peripheral interface (SPI). In the subsequent application process of the display panel, the driver chip calls the drive data in the RAM or flash according to the refresh rate. The drive data may include scan drive signals, gamma data and Demura data. The scan drive signal is the timing data of the scan signal of the display panel. The output frequency of the scan signal may be determined by the scan drive signal for driving a refresh rate corresponding to the output frequency. The gamma data provides a data voltage for the display panel to control the luminance of the display panel at one grayscale. Different refresh rates correspond to different display brightness values (DBVs). Therefore, different refresh rates are configured with different gamma data to enable the display panel to have the same luminance corresponding to the same grayscale at different refresh rates. The Demura data includes data voltage compensation data corresponding to each grayscale. When the refresh rates of the display panel are different, the luminance corresponding to the same grayscale is different before compensation. Different refresh rates correspond to different Demura data so that the luminance corresponding to the same grayscale is the same at different refresh rates. In conclusion, different application modes correspond to different drive data to ensure the display quality of the display panel at different refresh rates.

In S220, an operation instruction of the display panel is acquired.

In S230, an application mode of the display panel is determined according to the operation instruction. Different application modes correspond to different refresh rates.

In S240, a refresh rate of the display panel is switched to a refresh rate corresponding to the application mode according to the application mode of the display panel and drive data corresponding to the application mode is called.

In an embodiment, the step in which the application mode of the display panel is determined according to the operation instruction includes the steps described below.

If an always on display (AOD) mode is enabled in the display panel, or the display panel displays a static picture, and there is no operation instruction within a first preset time, the application mode of the display panel is determined to be a first mode.

The AOD of the display panel is a mode in which the display panel displays a single picture for a long time. At this time, the requirement for the refresh rate of the display panel is relatively low. Additionally, when the display panel displays the static picture and the user performs no operation instruction within the first preset time, the display picture of the display panel remains unchanged, and an always on display mode is enabled in the display panel after the first preset time. At this time, the requirement for the refresh rate of the display panel is also relatively low. In this case, the mode in which the always on display mode is enabled in the display panel and the application mode in which the display panel displays the static picture and there is no operation instruction within the first preset time are classified into one mode, that is, the first mode. The refresh rate of the first mode is relatively low, for example, 30 Hz. Additionally, the first preset time may be preset as required. For example, the first preset time may be several seconds.

If the operation instruction is a static-picture operation instruction, or if the operation instruction is a dynamic-picture interaction instruction and the frequency of the dynamic-picture interaction instruction within a second preset time is less than or equal to a first preset frequency, or the operation instruction is a playing instruction for playing a dynamic picture that lasts less than or equal to a third preset time, the application mode of the display panel is determined to be a second mode.

The static-picture operation instruction may be an instruction for operating a static picture. The operation instructions of the display panel may be operations such as the opening of an application and web page browsing. When the operation instruction is the static-picture operation instruction, the requirement for the refresh rate of the display panel is relatively conventional. When the operation instruction is the dynamic-picture interaction instruction and the frequency of the dynamic-picture interaction instruction within the second preset time is less than or equal to the first preset frequency, the operation instruction may be an application instruction of a first type of game. The application instruction of the first type of game may be an application of a mini game. For example, the mini game may be a game in which different graphics are presented in a game interface and the same graphics are connected to be eliminated. The second preset time may be a time period set as required, for example, unit time. The first preset frequency may be set according to an operation frequency within the second preset time when the user plays the mini game and other games.

Additionally, when the operation instruction is the playing instruction for playing the dynamic picture that lasts less than or equal to the third preset time, an operation such as short video playing may be performed. For example, the third preset time may be five minutes, and the playing of the dynamic picture that lasts less than or equal to the third preset time may be the playing of a short video in five minutes. At this time, the requirement for the refresh rate of the display panel is also relatively conventional. In this case, the application mode in which the operation instruction is the static-picture operation instruction, or the application mode in which the operation instruction is the dynamic-picture interaction instruction and the frequency of the dynamic-picture interaction instruction within the second preset time is less than or equal to the first preset frequency, or the application mode in which the operation instruction is the playing instruction for playing the dynamic picture that lasts less than or equal to the third preset time is classified as one mode, that is, the second mode. The refresh rate of the second mode is a conventional refresh rate. The refresh rate of the second mode is greater than the refresh rate of the first mode. For example, the refresh rates of the second mode may be 60 Hz and 90 Hz.

If the operation instruction is a dynamic-picture interaction instruction and the frequency of the dynamic-picture interaction instruction within the second preset time is greater than the first preset frequency, or the operation instruction is a playing instruction for playing a dynamic picture that lasts greater than the third preset time, the application mode of the display panel is determined to be a third mode. The refresh rate of the first mode is less than the refresh rate of the second mode. The refresh rate of the second mode is less than the refresh rate of the third mode.

The second preset time may be unit time. The frequency of the dynamic-picture interaction instruction is the number of interaction instructions in the unit time. The first preset frequency may be an interaction instruction frequency value set as required. For example, when a second type of game is applied, the frequency of the interaction instruction of a dynamic picture is relatively great. At this time, the first preset frequency may be set according to a difference between the frequency of the interaction instruction of the dynamic picture of the first type of game and the frequency of the interaction instruction of the dynamic picture of the second type of game. When the frequency of the dynamic-picture interaction instruction within the second preset time is greater than the first preset frequency, the interaction instruction of the dynamic picture may be an operation in a big game environment. A big game may be another game different from the mini game. The playing instruction for playing the dynamic picture that lasts greater than the third preset time may be a long video playing operation, for example, the playing of a movie. The two operation instructions require a relatively high refresh rate. Therefore, the application mode in which the operation instruction is the dynamic-picture interaction instruction and the frequency of the dynamic-picture interaction instruction within the second preset time is greater than the first preset frequency or the application mode in which the operation instruction is the playing instruction for playing the dynamic picture that lasts greater than the third preset time is classified as one mode, that is, the third mode. The refresh rate of the third mode is greater than the refresh rate of the second mode. For example, the refresh rates of the third mode may be 120 Hz and 144 Hz.

In an embodiment, the refresh rate of the first mode includes a first refresh rate. The second mode includes at least two different refresh rates, and the third mode includes at least two different refresh rates. The refresh rates in the same application mode share gamma data and Demura data. The scan drive signal at the minimum refresh rate in the same application mode is acquired by inserting a front porch parameter into the scan drive signal at the maximum refresh rate in the same application mode.

There may be multiple operation instructions in the same application mode. Different operation instructions may correspond to the same refresh rate according to the display requirements of the display panel or may correspond to different refresh rates. For example, the refresh rate of the second mode includes a second refresh rate and a third refresh rate. The refresh rate of the third mode includes a fourth refresh rate and a fifth refresh rate. The refresh rate requirement of the first mode is relatively low. Therefore, the refresh rate of the first mode may include a first refresh rate. For example, the first refresh rate may be 30 Hz. The refresh rate requirements of two operation instructions of the second mode are quite different. Therefore, the refresh rate of the second mode may include a second refresh rate and a third refresh rate. For example, the second refresh rate may be 60 Hz, and the third refresh rate may be 90 Hz. Similarly, the refresh rate requirements of two operation instructions of the third mode are quite different. Therefore, the refresh rate of the third mode may include a fourth refresh rate and a fifth refresh rate. For example, the fourth refresh rate may be 120 Hz, and the fifth refresh rate may be 144 Hz. When the same application mode includes at least two refresh rates, the at least two refresh rates share gamma data and Demura data to ensure that additionally set data is reduced on the basis of the normal display of the display panel at different refresh rates. Thus, the production difficulty and the production cost of the display panel are reduced, and the supply and the output of the display panel are improved.

Additionally, for scan drive signals of different refresh rates in the same application mode, the scan drive signal at the minimum refresh rate in the same application mode is acquired by inserting the front porch parameter into the scan drive signal at the maximum refresh rate in the same application mode to ensure that the additionally set data is reduced on the basis of the normal display of the display panel at different refresh rates. Thus, the production difficulty and the production cost of the display panel are reduced, and the supply and the output of the display panel are improved. For example, the second mode includes a second refresh rate and a third refresh rate. For example, the second refresh rate may be 60 Hz, and the third refresh rate may be 90 Hz. When the drive data corresponding to the second mode is the drive data corresponding to 90 Hz, the scan drive signal corresponding to 60 Hz may be acquired by inserting a front porch parameter into the scan drive signal corresponding to 90 Hz, that is, the front porch parameter is extended to increase the timing length of a scan drive circuit. The gamma data and the Demura data corresponding to 60 Hz may share the gamma data and the Demura data corresponding to 90 Hz. Similarly, the third mode includes a fourth refresh rate and a fifth refresh rate. For example, the fourth refresh rate may be 120 Hz, and the fifth refresh rate may be 144 Hz. When the drive data corresponding to the third mode is the drive data corresponding to 144 Hz, the scan drive signal corresponding to 120 Hz may be acquired by inserting a front porch parameter into the scan drive signal corresponding to the 144 Hz, that is, the front porch parameter is extended to increase the timing length of the scan drive circuit. The gamma data and the Demura data corresponding to 120 Hz may share the gamma data and the Demura data corresponding to 144 Hz.

In an embodiment, when the refresh rate of the second mode includes a second refresh rate and a third refresh rate, and the application mode of the display panel is the second mode, the method of driving a display panel further includes the steps below.

If the operation instruction is the static-picture operation instruction, the refresh rate of the second mode is determined to be the second refresh rate, if the operation instruction is the dynamic-picture interaction instruction and the frequency of the dynamic-picture interaction instruction within the second preset time is less than or equal to the first preset frequency, or if the operation instruction is the playing instruction for playing the dynamic picture that lasts less than or equal to the third preset time, the refresh rate of the second mode is determined to be the third refresh rate. The second refresh rate is less than the third refresh rate.

In the second mode, the refresh rate required by the static-picture operation instruction is different from the refresh rate required by the dynamic-picture interaction instruction of which the frequency within the second preset time is less than the first preset frequency and the refresh rate required by the playing instruction for playing the dynamic picture that lasts less than the third preset time. Therefore, specific operation instructions may correspond to different refresh rates in the same mode to improve the display effect of the display panel.

In an embodiment, the refresh rate of the third mode includes a fourth refresh rate and a fifth refresh rate. When the application mode of the display panel is the third mode, the method of driving a display panel further includes the steps below.

If the operation instruction is the playing instruction for playing the dynamic picture that lasts greater than the third preset time, the refresh rate of the third mode is determined to be the fourth refresh rate. If the operation instruction is the dynamic-picture interaction instruction and the frequency of the dynamic-picture interaction instruction within the second preset time is greater than the first preset frequency, the refresh rate of the third mode is determined to be the fifth refresh rate. The fourth refresh rate is less than the fifth refresh rate.

Similarly, in the third mode, the refresh rate required by the dynamic-picture interaction instruction of which the frequency within the second preset time is greater than the first preset frequency is different from the refresh rate required by the playing instruction for playing the dynamic picture that lasts greater than the third preset time. Therefore, specific operation instructions may correspond to different refresh rates in the same mode to improve the display effect of the display panel.

After the operation instruction of the display panel is determined, the refresh rate of the display panel may be switched to a refresh rate corresponding to the application mode according to the operation instruction. Then the scan drive signal, gamma data and Demura data corresponding to the refresh rate are called so that the automatic switch of the refresh rate of the display panel is achieved. Additionally, when the refresh rate of the display panel is switched from a low rate to a high rate, it is necessary to switch the crystal oscillator frequency in the driver chip. Thus, the stable matching of related timing when the refresh rate of the display panel is switched is achieved. For example, when the refresh rate of the display panel is switched from 90 Hz to 120 Hz or 144 Hz, the crystal oscillator frequency of the driver chip of the display panel may be synchronously switched from 100 MHz to 130 MHz to achieve the stable matching of 120 Hz or 144 Hz related timing.

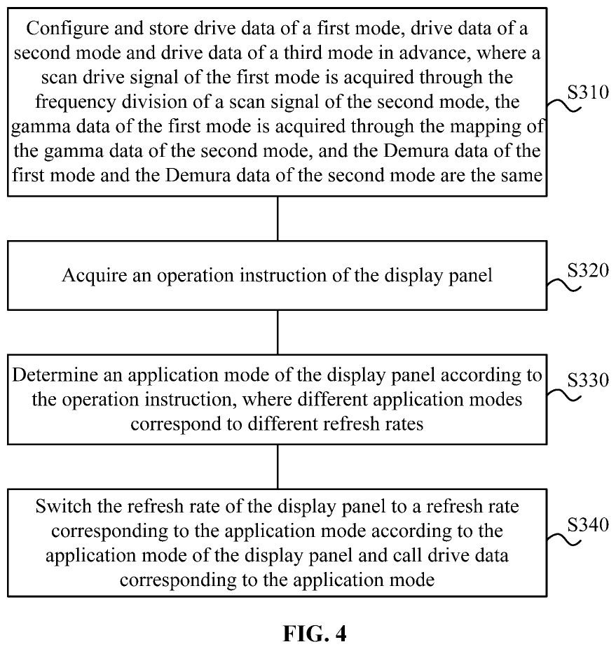

FIG. 4 is a flowchart of another method of driving a display panel according to an embodiment of the present application. As shown in FIG. 4, this method includes S310 to S340.

In S310, drive data of a first mode, drive data of a second mode and drive data of a third mode are configured and stored in advance. A scan drive signal of the first mode is acquired through the frequency division of a scan signal of the second mode. The gamma data of the first mode is acquired through the mapping of the gamma data of the second mode. The Demura data of the first mode and the Demura data of the second mode are the same.

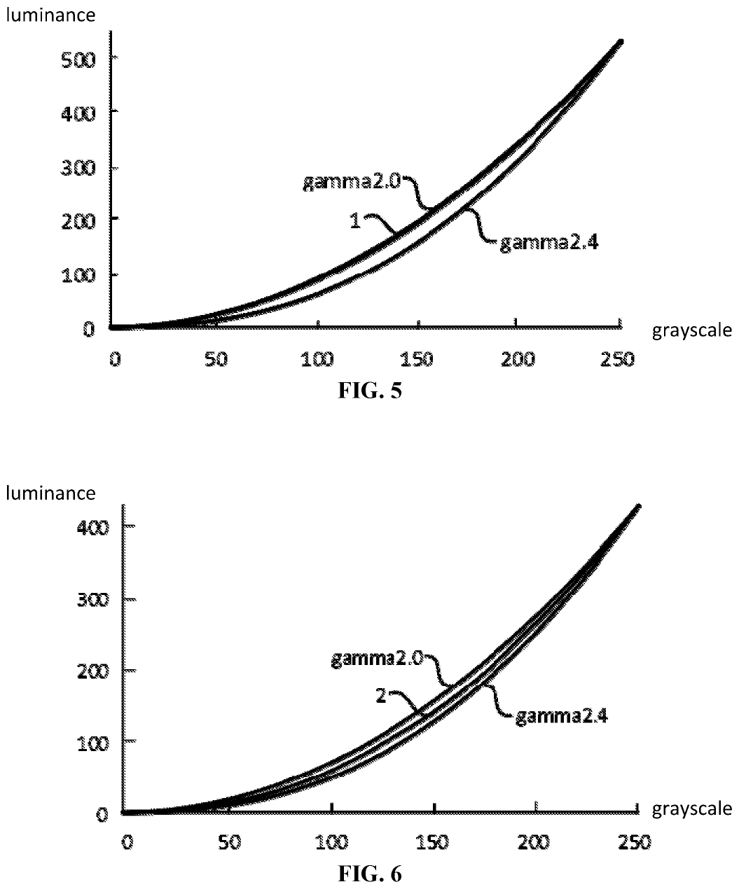

With the increase of the refresh rate, a high refresh rate is generally achieved based on the change of the crystal oscillator frequency in the driver chip. At this time, a relatively great change in driver data occurs. For example, relative to the refresh rate of the second mode, the refresh rate of the third mode is achieved based on the change of the crystal oscillator frequency in the driver chip. When the drive data of the second mode and the drive data of the third mode are shared, the luminance of the display panel is shifted. The drive data of the second mode and the drive data of the third mode are configured and stored in advance to reduce the luminance shift of the display panel when the refresh rate of the second mode is switched to the refresh rate of the third mode. For example, when the refresh rate of the second mode includes 90 Hz, and the refresh rate of the third mode includes 120 Hz and 144 Hz, FIG. 5 is a luminance-grayscale graph illustrating that the gamma data of 90 Hz is shared with 120 Hz, and FIG. 6 is a luminance-grayscale graph illustrating that the gamma data of 144 Hz is shared with 120 Hz, where an abscissa is a grayscale and an ordinate is a luminance Curve 1 is a luminance-grayscale curve illustrating a case where the gamma data of 90 Hz is shared with 120 Hz. Curve 2 is a luminance-grayscale curve illustrating a case where the gamma data of 144 Hz is shared with 120 Hz. Gamma 2.0 is a curve having a gamma value of 2.0. Gamma 2.4 is a curve having a gamma value of 2.4. As shown in FIGS. 5 and 6, when the gamma data of 90 Hz is shared with 120 Hz, the luminance-grayscale curve is biased towards the curve having the gamma value of 2.0. At this time, the luminance-grayscale curve of 120 Hz is not suitable for human eyes. When the gamma data of 144 Hz is shared with 120 Hz, the luminance-grayscale curve is located between the curve having the gamma value of 2.0 and the curve having the gamma value of 2.4. At this time, the luminance-grayscale curve of 120 Hz is suitable for the human eyes. The drive data of the second mode and the drive data of the third mode are configured and stored in advance so that the drive data of the second mode is called by the display panel in the application mode of the second mode, and the drive data of the third mode is called by the display panel in the application mode of the third mode. Thus, the luminance-grayscale curve may be prevented from being shifted in the application mode of the third mode. Moreover, the luminance of the display panel in the third mode is more suitable for human eyes, and the experience effect of the display panel is improved. Additionally, the drive data of the second mode and the drive data of the third mode are configured respectively to ensure the display uniformity of the display panel in the application mode of the third mode and to reduce the flicker of a pattern during the display of the display panel. For example, when the refresh rate of the second mode includes 90 Hz, and 90 Hz is used as a conventional rate, the refresh rate of the third mode includes 120 Hz. Table 1 shows the uniformity of the display panel at different grayscales when the refresh rate of the display panel is 90 Hz. Table 2 shows the uniformity of the display panel at different grayscales when the refresh rate of the display panel is 120 Hz. Table 3 shows flicker values and average values at different refresh rates. The uniformity of the display panel is the ratio of the minimum luminance to the maximum luminance at the same grayscale in 9 luminance acquisition points 1-9 in the display panel. As can be seen from Table 1 and Table 2, there is no significant change between the display uniformity of the display panel at different grayscales in the application mode of the second mode and the display uniformity of the display panel at different grayscales in the application mode of the third mode. Thus, the display uniformity of the display panel at high refresh rates can be ensured, and the display quality of the display panel at the high refresh rates is ensured. As can be seen from Table 3, during the switch process of the refresh rate of the display panel from low to high, the flicker is slightly reduced. That is, the drive data of the second mode and the drive data of the third mode are configured respectively to reduce the flicker of the display panel at the high refresh rates. Thus, the display quality of the display panel at the high refresh rates is improved.

TABLE 1

| 90 Hz | Gray255 | Gray128 | Gray64 | Gray32 |
|---|---|---|---|---|
| 1 | 420.1 | 97.5 | 21.7 | 4.8 |
| 2 | 423.4 | 97.3 | 21.68 | 4.88 |
| 3 | 429.2 | 97.9 | 22.15 | 5.01 |
| 4 | 428.1 | 94.9 | 20.75 | 4.43 |
| 5 | 429.3 | 94.6 | 20.8 | 4.44 |
| 6 | 434.1 | 96.7 | 21.08 | 4.58 |
| 7 | 464.5 | 97.1 | 20.8 | 4.44 |
| 8 | 454.6 | 96.4 | 20.66 | 4.5 |
| 9 | 475.7 | 97.7 | 20.64 | 4.4 |
| Uniformity | 88.31% | 96.63% | 93.18% | 87.82% |

TABLE 2

| 120 Hz | Gray255 | Gray128 | Gray64 | Gray32 |
|---|---|---|---|---|
| 1 | 424.6 | 99.7 | 21.8 | 4.8 |
| 2 | 425.4 | 98.68 | 21.9 | 4.88 |
| 3 | 429.2 | 99.8 | 22.4 | 5.01 |
| 4 | 430.1 | 96.1 | 20.75 | 4.43 |
| 5 | 429.5 | 96.1 | 20.6 | 4.44 |
| 6 | 434 | 97.8 | 21.08 | 4.58 |
| 7 | 467.9 | 97.8 | 20.8 | 4.44 |
| 8 | 461.4 | 96.8 | 20.56 | 4.5 |
| 9 | 471 | 97.4 | 20.44 | 4.4 |
| Uniformity | 90.15% | 96.29% | 91.25% | 87.82% |

TABLE 3

| Rate | Flicker | | | Average Value |
|---|---|---|---|---|
| 60 Hz | −71.24286 | −71.1999 | −71.30909 | −71.25062 |
| 90 Hz | −73.00115 | −73.71088 | −74.0948 | −73.60228 |
| 120 Hz | −78.29192 | −78.24052 | −78.26307 | −78.26517 |

Additionally, since the refresh rate of the second mode is greater than the refresh rate of the first mode, after the drive data of the second mode is configured, the drive data of the first mode may be computed according to the drive data of the second mode, and then the drive data of the first mode is stored in advance. Thus, the display panel may directly call the drive data of the first mode when other application modes are switched to the first mode. For example, the scan drive signal of the first mode may be acquired through the frequency division of the scan drive signal of the second mode. The scan drive signal of the second mode may acquire the scan drive signal of the first mode through the frequency division. In this manner, the accuracy of the scan drive signal of the first mode can be ensured, and at the same time, the additional computation of the scan drive signal of the first mode can be avoided. Thus, the production difficulty and the production cost of the display panel are reduced, and the supply and the output of the display panel are improved. Similarly, the gamma data of the first mode may be acquired through the mapping of the gamma data of the second mode. Additionally, when the application mode of the display panel is the first mode, generally an always on display mode is on in the display panel, or the display panel displays a static picture and there is no operation instruction within the first preset time, and the user does not have a high requirement for the display uniformity of the display panel. Therefore, the Demura data of the first mode may share the Demura data of the second mode. In this manner, the requirement of the user is satisfied, and the additional configuration of the Demura data of the first mode can be avoided. Thus, the production difficulty and the production cost of the display panel are reduced, and the supply and the output of the display panel are improved.

In S320, an operation instruction of the display panel is acquired.

In S330, an application mode of the display panel is determined according to the operation instruction. Different application modes correspond to different refresh rates.

In S340, the refresh rate of the display panel is switched to a refresh rate corresponding to the application mode according to the application mode of the display panel and drive data corresponding to the application mode is called.

When the current application mode of the display panel is the third mode, if it is detected that the application mode corresponding to a new operation instruction is the first mode or the second mode, the method further includes the steps below.

Whether the operation instruction corresponding to the third mode is detected by the display panel in a fourth preset time is determined.

If the operation instruction corresponding to the third mode is detected by the display panel within the fourth preset time, the application mode of the display panel is determined to be an application mode corresponding to a new operation instruction.

If the operation instruction corresponding to the third mode is detected by the display panel within the fourth preset time, the application mode of the display panel is determined to be the third mode.

When the application mode of the display panel is the third mode, the refresh rate of the display panel is relatively high. When a new operation instruction is detected, and an application mode corresponding to the new operation instruction is the first mode or the second mode, whether the application mode of the display panel changes is changed may be determined according to whether the operation instruction corresponding to the third mode is detected within the fourth preset time. If the operation instruction corresponding to the third mode is not detected within the fourth preset time, the application mode of the display panel is determined according to the new operation instruction. At this time, the application mode of the display panel may be the first mode or the second mode. If the operation instruction corresponding to the third mode is detected within the fourth preset time, the application mode of the display panel is determined to still be the third mode. Thus, the display panel is prevented from quickly switching the application mode under the new operation instruction, and the switch frequency of the application mode of the display panel is reduced. Moreover, the user's comfort in using the display panel can be ensured. The fourth preset time may be set as required, for example, 10 s. For example, when the operation instruction of the display panel is the playing instruction for playing the dynamic picture that lasts greater than the third preset time to enable the application mode of the display panel to be the third mode, if a new operation instruction is detected, for example, an operation instruction for the display panel to switch from the dynamic picture to a static picture, timekeeping begins. If the operation instruction corresponding to the third mode is not detected within the fourth preset time, for example, an operation instruction for the display panel to switch back to the dynamic picture and continue playing the dynamic picture, the application mode of the display panel is determined according to the new operation instruction. At this time, the application mode of the display panel may be the first mode or the second mode. If the operation instruction corresponding to the third mode is detected within the fourth preset time, the application mode of the display panel is determined to be the third mode. In this manner, the speed of the switch between the new operation instruction and the operation instruction corresponding to the third mode is prevented from being relatively fast so that the application mode of the display panel is prevented from being switched frequently, and the switch frequency of the application mode is reduced. Thus, the user's comfort in using the display panel can be ensured. Similarly, when the operation instruction of the display panel is the dynamic-picture interaction instruction, and the frequency of the dynamic-picture interaction instruction within the second preset time is greater than the first preset frequency to enable the application mode of the display panel to be the third mode, if a new operation instruction, for example, an operation instruction for the display panel to switch from the third mode, is detected, the following operations are performed: If the operation instruction corresponding to the third mode, for example, an operation instruction for the display panel to switch back to the dynamic picture and continue playing the dynamic picture, is not detected within the fourth preset time, the application mode of the display panel is determined according to the new operation instruction; and if the operation instruction corresponding to the third mode, for example, an operation instruction for the display panel to switch back to the dynamic picture of the third mode, is detected within the fourth preset time, the application mode of the display panel is determined to be the third mode. In this manner, the switch frequency of the application mode can also be reduced. Thus, the user's comfort in using the display panel can also be ensured.

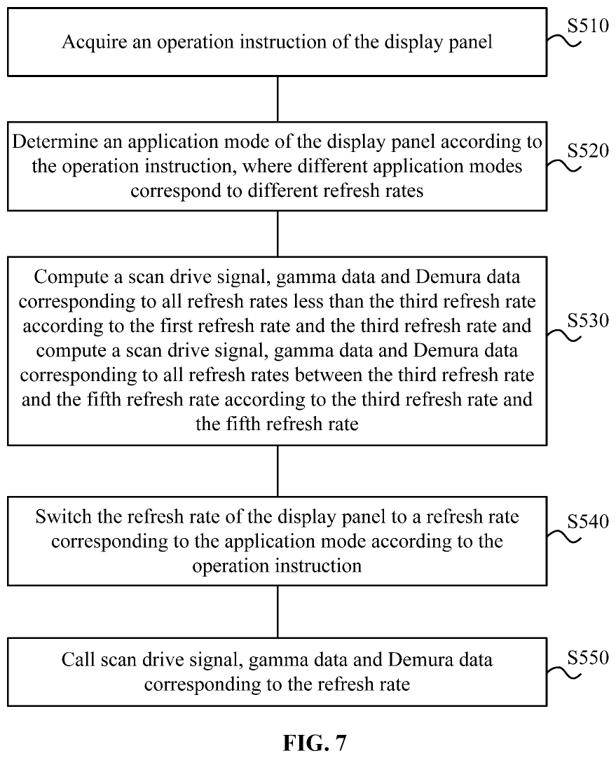

FIG. 7 is a flowchart of another method of driving a display panel according to an embodiment of the present application. As shown in FIG. 7, when the refresh rate of the third mode includes a fourth refresh rate and a fifth refresh rate, and the fourth refresh rate is less than the fifth refresh rate, this method includes S510 to S550.

In S510, an operation instruction of the display panel is acquired.

In S520, an application mode of the display panel is determined according to the operation instruction. Different application modes correspond to different refresh rates.

In S530, scan drive signals, gamma data and Demura data corresponding to all refresh rates less than the third refresh rate are computed according to the first refresh rate and the third refresh rate and scan drive signals, gamma data and Demura data corresponding to all refresh rates between the third refresh rate and the fifth refresh rate are computed according to the third refresh rate and the fifth refresh rate.

The third refresh rate may be a basic refresh rate of the display panel, that is, an initialization refresh rate of the display panel. Other refresh rates of the display panel may be switched on the basis of the third refresh rate. Additionally, the first refresh rate may be obtained through the frequency division of the third refresh rate to ensure the accuracy of the first refresh rate. The scan drive signals, gamma data and Demura data corresponding to all refresh rates less than the third refresh rate are computed according to the first refresh rate and the third refresh rate. In this manner, any low refresh rate may be switched according to the operation instruction to achieve accurate low rate adaptation. Thus, the application modes of the first mode and the second mode are energy-saving and smooth. For example, the scan drive signals, gamma data and Demura data corresponding to refresh rates less than the third refresh rate may be fitted according to the scan drive signals, gamma data and Demura data corresponding to the first refresh rate and the third refresh rate. The scan drive signals, gamma data and Demura data corresponding to all refresh rates between the third refresh rate and the fifth refresh rate are computed according to the third refresh rate and the fifth refresh rate. In this manner, any high refresh rate may also be switched according to the operation instruction to achieve accurate high rate adaptation. Thus, the application mode of the third mode is smooth, and the user experience of the display panel is improved. For example, the scan drive signals, gamma data and Demura data corresponding to all refresh rates between the third refresh rate and the fifth refresh rate may be fitted according to the scan drive signals, gamma data and Demura data corresponding to the third refresh rate and the fifth refresh rate.

In S540, the refresh rate of the display panel is switched to a refresh rate corresponding to the application mode according to the operation instruction.

In S550, the scan drive signal, gamma data and Demura data corresponding to the refresh rate are called.

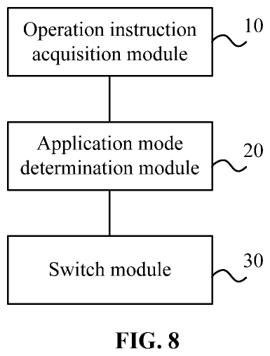

An embodiment of the present application provides a display panel driving apparatus. As shown in FIG. 8, the display panel driving apparatus includes an operation instruction acquisition module 10, an application mode determination module 20 and a switch module 30.

The operation instruction acquisition module 10 is configured to acquire an operation instruction of the display panel.

The application mode determination module 20 is configured to determine an application mode of the display panel according to the operation instruction. Different application modes correspond to different refresh rates.

The switch module 30 is configured to switch a refresh rate of the display panel to a refresh rate corresponding to the application mode according to the application mode of the display panel and call the drive data corresponding to the application mode.

In the technical schemes of this embodiment of the present application, after the operation instruction acquisition module acquires the operation instruction of the display panel, the application mode determination module determines the application mode of the display panel according to the operation instruction, and then the switch module automatically switches the refresh rate of the display panel according to the application mode. In this manner, different application modes of the display panel correspond to different refresh rates. Thus, the seamless and smooth switch of the refresh rate of the display panel can be achieved to avoid problems such as a screen flicker and a color cast. Moreover, phenomena such as a lag, vertigo and a motion blur at a high refresh rate can be effectively solved, and the experience effect of the high refresh rate can be improved. Additionally, when the switch module switches the refresh rate of the display panel, the drive data corresponding to the application mode is called to ensure the display quality of the display panel at different refresh rates and reduce the number of complex instructions sent by the mainboard. Thus, the electricity consumption of the mainboard can be saved, and the standby time of the display panel can be prolonged.

In an embodiment, the display panel driving apparatus further includes an operation instruction determination module.

The operation instruction determination module is configured to, after the current application mode of the display panel is the third mode, and an application mode corresponding to a new operation instruction is detected to be the first mode or the second mode, determine whether an operation instruction corresponding to the third mode is detected by the display panel within the fourth preset time.

The application mode determination module is further configured to, if the operation instruction corresponding to the third mode is not detected by the display panel within the fourth preset time, determine that the application mode of the display panel is the application mode corresponding to the new operation instruction; and if the operation instruction corresponding to the third mode is detected by the display panel within the fourth preset time, determine that the application mode of the display panel is the third mode.

When the current application mode of the display panel is the third mode, after the application mode corresponding to the new operation instruction is detected to be the first mode or the second mode, the operation instruction determination module determines whether the operation instruction corresponding to the third mode is detected by the display panel within the fourth preset time. If the operation instruction corresponding to the third mode is not detected by the display panel within the fourth preset time, the operation instruction determination module may generate a first signal and output the first signal to the application mode determination module, and the application mode determination module determines that the application mode of the display panel is the application mode corresponding to the new operation instruction according to the first signal. If the operation instruction corresponding to the third mode is detected by the display panel within the fourth preset time, the operation instruction determination module may generate a second signal and output the second signal to the application mode determination module, and the application mode determination module determines that the application mode of the display panel is the third mode according to the second signal. The operation instruction determination module determines that the current application mode of the display panel is the third mode, detects that the application mode corresponding to the new operation instruction is the first mode or the second mode, and then determines whether the operation instruction corresponding to the third application mode is detected within the fourth preset time, so that the display panel can be prevented from quickly switching the application mode under the new operation instruction according to the operation instruction determination module and the application mode determination module. Thus, the switch frequency of the application mode of the display panel is reduced, and the user's comfort in using the display panel can be ensured.

What is claimed is:

1. A method of driving a display panel, comprising:
acquiring an operation instruction of the display panel;
determining an application mode of the display panel according to the operation instruction, wherein different application modes correspond to different refresh rates; and
switching a refresh rate of the display panel to a refresh rate corresponding to the application mode according to the application mode of the display panel and calling drive data corresponding to the application mode.

2. The method according to claim 1, before acquiring the operation instruction of the display panel, the method further comprising:
configuring and storing drive data corresponding to different application modes, wherein the drive data comprises scan drive signals, gamma data and Demura data.

3. The method according to claim 1, wherein determining the application mode of the display panel according to the operation instruction comprises:
in response to an always on display mode being enabled in the display panel or in response to the display panel displaying a static picture and no operation instruction exists within a first preset time, determining that the application mode of the display panel is a first mode;
in response to the operation instruction being a static-picture operation instruction, in response to the operation instruction being a dynamic-picture interaction instruction and a frequency of the dynamic-picture interaction instruction within a second preset time is less than or equal to a first preset frequency, or in response to the operation instruction being a playing instruction for playing a dynamic picture that lasts less than or equal to a third preset time, determining that the application mode of the display panel is a second mode; and
in response to the operation instruction being a dynamic-picture interaction instruction and a frequency of the dynamic-picture interaction instruction within the second preset time is greater than the first preset frequency, or in response to the operation instruction being a playing instruction for playing a dynamic picture that lasts greater than the third preset time, determining that the application mode of the display panel is a third mode, wherein a refresh rate of the first mode is less than a refresh rate of the second mode, and the refresh rate of the second mode is less than a refresh rate of the third mode.

4. The method according to claim 2, wherein determining the application mode of the display panel according to the operation instruction comprises:
in response to an always on display mode being enabled in the display panel or in response to the display panel displaying a static picture and no operation instruction exists within a first preset time, determining that the application mode of the display panel is a first mode;
in response to the operation instruction being a static-picture operation instruction, in response to the operation instruction being a dynamic-picture interaction instruction and a frequency of the dynamic-picture interaction instruction within a second preset time is less than or equal to a first preset frequency, or in response to the operation instruction being a playing instruction for playing a dynamic picture that lasts less than or equal to a third preset time, determining that the application mode of the display panel is a second mode; and
in response to the operation instruction being a dynamic-picture interaction instruction and a frequency of the dynamic-picture interaction instruction within the second preset time is greater than the first preset frequency, or in response to the operation instruction being a playing instruction for playing a dynamic picture that lasts greater than the third preset time, determining that the application mode of the display panel is a third mode, wherein a refresh rate of the first mode is less than a refresh rate of the second mode, and the refresh rate of the second mode is less than a refresh rate of the third mode.

5. The method according to claim 4, wherein configuring and storing the drive data corresponding to the different application modes comprises:
configuring and storing drive data of the first mode, drive data of the second mode and drive data of the third mode in advance.

6. The method according to claim 5, wherein a scan drive signal of the first mode is acquired through frequency division of a scan drive signal of the second mode, gamma data of the first mode is acquired through mapping of gamma data of the second mode, and Demura data of the first mode and Demura data of the second mode are the same.

7. The method according to claim 4, wherein the refresh rate of the first mode comprises a first refresh rate, the second mode comprises at least two different refresh rates, and the third mode comprises at least two different refresh rates, wherein refresh rates in a same application mode share gamma data and Demura data, and a scan drive signal at a minimum refresh rate in the same application mode is acquired by inserting a front porch parameter into a scan drive signal at a maximum refresh rate in the same application mode.

8. The method according to claim 7, wherein the refresh rate of the second mode comprises a second refresh rate and a third refresh rate, wherein the second refresh rate is less than the third refresh rate; and wherein when the application mode of the display panel is the second mode, the method further comprises:
in response to the operation instruction being the static-picture operation instruction, determining that the refresh rate of the second mode is the second refresh rate; and
in response to the operation instruction being the dynamic-picture interaction instruction and the frequency of the dynamic-picture interaction instruction within the second preset time is less than or equal to the first preset frequency, or in response to the operation instruction being the playing instruction for playing the dynamic picture that lasts less than or equal to the third preset time, determining that the refresh rate of the second mode is the third refresh rate.

9. The method according to claim 7, wherein the refresh rate of the third mode comprises a fourth refresh rate and a fifth refresh rate, and the fourth refresh rate is less than the fifth refresh rate; and wherein when the application mode of the display panel is the third mode, the method further comprises:
in response to the operation instruction being the playing instruction for playing the dynamic picture that lasts greater than the third preset time, determining that the refresh rate of the third mode is the fourth refresh rate; and
in response to the operation instruction being the dynamic-picture interaction instruction and the frequency of the dynamic-picture interaction instruction within the second preset time is greater than the first preset frequency, determining that the refresh rate of the third mode is the fifth refresh rate.

10. The method according to claim 3, wherein in a case where a current application mode of the display panel is the third mode, after detecting that an application mode corresponding to a new operation instruction is the first mode or the second mode, the method further comprises:
determining whether an operation instruction corresponding to the third mode is detected by the display panel within a fourth preset time;
in response to the operation instruction corresponding to the third mode being not detected by the display panel within the fourth preset time, determining that the application mode of the display panel is the application mode corresponding to the new operation instruction; and
in response to the operation instruction corresponding to the third mode being detected by the display panel within the fourth preset time, determining that the application mode of the display panel is the third mode.

11. The method according to claim 8, wherein the refresh rate of the third mode comprises a fourth refresh rate and a fifth refresh rate, and the fourth refresh rate is less than the fifth refresh rate; and wherein switching the refresh rate of the display panel to the refresh rate corresponding to the application mode according to the application mode of the display panel and calling the drive data corresponding to the application mode comprise:
computing a scan drive signal, gamma data and Demura data corresponding to each refresh rate less than the third refresh rate according to the first refresh rate and the third refresh rate; and
computing a scan drive signal, gamma data and Demura data corresponding to each refresh rate between the third refresh rate and the fifth refresh rate according to the third refresh rate and the fifth refresh rate;
switching the refresh rate of the display panel to the refresh rate corresponding to the application mode according to the operation instruction; and
calling a scan drive signal, gamma data and Demura data corresponding to the refresh rate.

12. The method according to claim 1, before acquiring the operation instruction of the display panel, the method further comprising: a power-up process of the display panel; and after powering up the display panel, the method further comprising: loading data programmed in a programming process into a driver chip of the display panel and loading an initialization code into the driver chip of the display panel to enable the display panel to be driven for displaying normally.

13. The method according to claim 12, wherein the driver chip of the display panel comprises a random-access memory (RAM), and the RAM is configured to store a fixed program and data required for driving the display panel.

14. The method according to claim 13, wherein the RAM stores drive data, the RAM further stores set register values of the driver chip of the display panel, and different register values correspond to different application modes of the display panel.

15. The method according to claim 12, wherein the drive data is stored in a flash, and the flash is communicatively connected to the driver chip of the display panel through a serial peripheral interface (SPI).

16. The method according to claim 7, wherein the first refresh rate is 30 Hz.

17. The method according to claim 8, wherein the second refresh rate is 60 Hz, and the third refresh rate is 90 Hz.

18. The method according to claim 9, wherein the fourth refresh rate is 120 Hz, and the fifth refresh rate is 144 Hz.

19. A display panel driving apparatus, comprising:
an operation instruction acquisition module, which is configured to acquire an operation instruction of the display panel;
an application mode determination module, which is configured to determine an application mode of the display panel according to the operation instruction, wherein different application modes correspond to different refresh rates; and
a switch module, which is configured to switch a refresh rate of the display panel to a refresh rate corresponding to the application mode according to the application mode of the display panel and call drive data corresponding to the application mode.

20. The display panel driving apparatus according to claim 19, further comprising:
an operation instruction determination module, which is configured to, in a case where a current application mode of the display panel is a third mode, after an application mode corresponding to a new operation instruction is detected to be a first mode or a second mode, determine whether an operation instruction corresponding to the third mode is detected by the display panel within a fourth preset time;
wherein the application mode determination module is further configured to, in response to the operation instruction corresponding to the third mode being not detected by the display panel within the fourth preset time, determine that the application mode of the display panel is the application mode corresponding to the new operation instruction, and in response to the operation instruction corresponding to the third mode being detected by the display panel within the fourth preset time, determine that the application mode of the display panel is the third mode.
